(19) United States
(12) Patent Application Publication
(10) Pub. No.: US 2022/0060012 A1
(43) Pub. Date: Feb. 24, 2022

(54) CIRCUIT BREAKER

(71) Applicant: Ellenberger & Poensgen GmbH, Altdorf (DE)

(72) Inventors: Alexander Labs, Winkelhaid (DE); Christian Strobl, Nuernberg (DE)

(21) Appl. No.: 17/516,873

(22) Filed: Nov. 2, 2021

Related U.S. Application Data
(63) Continuation of application No. PCT/EP2020/060668, filed on Apr. 16, 2020.

(30) Foreign Application Priority Data
May 2, 2019 (DE) 10 2019 206 267.9

(51) Int. Cl. H02H 3/08; H02H 1/00

(52) U.S. Cl. CPC H02H 3/08; H02H 1/0007

(57) ABSTRACT

A circuit breaker has a main current path which has a controllable first switching element with a first control input that is connected to a controllable second switching element of a drive circuit. The drive circuit has a current sensor which is coupled to the main current path and which has two outputs. An electrical voltage which is applied between the two outputs is dependent on an electric current conducted by way of the main current path. Each of the outputs is connected to in each case one input of a microcontroller-free characteristic curve circuit with two further outputs, and the second switching element is operated depending on a further electrical voltage which is applied between the further outputs. A functional relationship exists between the further electrical voltage and the electrical voltage.

### CROSS-REFERENCE TO RELATED APPLICATION

This application is a continuation, under 35 U.S.C. § 120, of copending International Patent Application PCT/EP2020/060668, filed Apr. 16, 2020, which designated the United States; this application also claims the priority, under 35 U.S.C. § 119, of German patent application DE 10 2019 206 267.9, filed May 2, 2019; the prior applications are herewith incorporated by reference in their entirety.

### FIELD AND BACKGROUND OF THE INVENTION

The invention relates to a circuit breaker having a main current path, which has a controllable first switching element with a first control input. The first control input is connected to a controllable second switching element of a drive circuit and it is thus actuated by way of the second switching element.

Telecommunications systems or data center systems are commonly connected to an electrical supply network. An AC voltage, whose frequency is 50 Hz or 60 Hz, is usually provided by way of the supply network. Since the functional components of the system are usually actuated by means of DC voltage, a rectifier of the system is connected to the electrical supply network. The rectifier is used to convert the AC voltage to a DC voltage, which may be between 10 V and several 100 V, and which is fed into a DC circuit. The DC circuit is used to electrically contact-connect the further components of the system and these are therefore energized by the DC circuit.

If the rectifier or one of the components fails, it is possible that an excessive electrical current arises, which may destroy the further components or other constituent parts of the infrastructure in the DC circuit. To prevent this, it is necessary to interrupt the DC circuit and/or the connection of the components to the DC circuit. Circuit breakers are conventionally used for this purpose. They have a switching element that is actuated depending on the presence of the fault behavior, such as an excessive electric current.

In one alternative, the switching element is formed by a bimetal strip, for example, by way of which the electric current is conducted. In the case of a flow of an excessive electric current through the bimetal strip, the sides of the strip are lengthened unequally, with the result that the strip is bent. As a result thereof, one end of the bimetal strip comes away from a (fixed) contact of the circuit breaker and the flow of electric current is interrupted. Therefore, no additional components are necessary to monitor the electric current, as a result of which material costs are comparatively low. However, the manufacture of the bimetal strip is afflicted by comparatively large tolerances, with the result that the mechanical prestress of the bimetal strip has to be set exactly and adjusted to the respective circuit breaker upon assembly of the strip. Therefore, production time and also production costs are increased.

Furthermore, the bimetal strip can be supplemented with a coil arrangement. This then thermally magnetic circuit breaker can react to short overcurrent events more quickly in comparison with the purely thermal principle. However, large tolerances can also arise here, which make it difficult to satisfy the protection requirements of the DC circuit (DC network) with possibly very high, short current peaks during rated operation and with limited continuous short-circuit power and the most rapid possible required disconnection in the event of a fault.

An alternative thereto makes provision for the switching element to be designed independently of the determination of the fault. In this case, the switching element is a semiconductor switch or a relay, for example. These are actuated by means of a drive circuit, which conventionally has a microprocessor and a current sensor. In this case, the electric current conducted by the switching element is detected by means of the current sensor. The current sensor is coupled to the microprocessor in terms of signal technology. As a result the knowledge about the value of the presently flowing electric current is present in the microprocessor. The microprocessor is used to perform evaluation thereof, and the switching element is actuated by way of the microprocessor depending on the evaluation. It is thus possible by means of programming and/or selection of the microprocessor to implement different switching characteristics of the circuit breaker. It is therefore possible to use the circuit breaker in different cases of application, wherein it is necessary only to program the microprocessor accordingly. However, production costs and a susceptibility to interference are increased on account of the microprocessor.

### SUMMARY OF THE INVENTION

It is accordingly an object of the invention to provide a circuit breaker which overcomes the above-mentioned disadvantages of the heretofore-known devices and methods of this general type and which provides for a particularly suitable circuit breaker in which production costs are advantageously reduced and wherein an adjustment to different applications is expediently increased.

With the above and other objects in view there is provided, in accordance with the invention, a circuit breaker, comprising:

a main current path for conducting an electric current, and a controllable first switching element in the main current path, the first switching element having a first control input;

a current sensor coupled to the main current path, the current sensor having two outputs, with an electrical voltage applied between the two outputs being dependent on the electric current conducted by the main current path;

each of the two outputs of the current sensor being connected to a respective input of a microcontroller-free characteristic curve circuit; and

a controllable second switching element of a drive circuit connected to the first control input of the first switching element, the controllable second switching element being actuated in dependence on a further electrical voltage applied between the outputs of the microcontroller-free characteristic curve circuit, wherein a functional relationship exists between the further electrical voltage and the electrical voltage between the two outputs of the current sensor.

The circuit breaker is used to protect a component part, such as a line or another component, for example a load unit or a load. For this purpose, a specific electric current is normally conducted by way of the circuit breaker. In the case of fault behavior, for example an overcurrent, a short-circuit current or a fault current, the circuit breaker is triggered so that the flow of the electric current (current flow) is interrupted. The electric current normally conducted by means of the circuit breaker is greater than 0.5 A, 1 A, 5 A, 10 A, 20 A or 50 A, for example. In particular, the maximum electric current normally conducted is less than 200 A, 150 A or 100 A. A direct current is particularly preferably conducted by means of the circuit breaker. The circuit breaker is suitable, in particular provided and configured, for this purpose. If the electric current is interrupted, in particular an electrical voltage, which is greater than 12 V, 48 V, 100 V, 200 V, is applied to the circuit breaker. For example, the electrical voltage is lower than 2000 V, 1000 V, 900 V or 800 V. In particular, the circuit breaker is a high-voltage circuit breaker.

By way of example, the circuit breaker may be used in a motor vehicle and thus form a constituent part of the motor vehicle. The motor vehicle expediently has a high-voltage energy storage device, which is electrically connected to a drive, such as an electric motor. In the assembled state, the circuit breaker is introduced into a line between the high-voltage energy store and the drive, which is preferably a constituent part of a high-voltage on-board power supply system. The circuit breaker is suitable, i.e., configured, for this purpose. In an alternative example, the circuit breaker may be used in a charging column for an electric vehicle.

In a particularly preferred alternative, the circuit breaker is used to protect a telecommunications system, for example a mobile radio system, or in a data center system. In this case, the circuit breaker is introduced into a DC circuit (DC network), which is fed by means of a rectifier of the respective system. The rectifier is used, in particular, to transform an AC voltage provided by means of an electrical supply network to a DC voltage, wherein the AC voltage in particular has a frequency of 50 Hz or 60 Hz. A DC voltage, which is between 10 V and several 100 V, is expediently applied in the DC circuit. For example, the applied electrical (DC) voltage is between 10 V and 500 V, between 50 V and 200 V or between 100 V and 150 V. The circuit breaker is preferably used to protect the DC circuit or a component of the respective system that is fed by means of the DC circuit.

The circuit breaker has a main current path having a controllable first switching element. During operation as intended, the electric current is conducted by means of the main current path. The switching element is arranged within the main current path in such a way that the electric current flowing through the main current path can be interrupted by means of the first switching element. Therefore, when the first switching element is actuated, the main current path is interrupted. The first switching element expediently has two operating contacts, which are a constituent part of the main current path. When the first switching element is switched, the electrical resistance between the two operating contacts expediently increases.

The first switching element is designed to be controllable and has a first control input. The first control input is not a constituent part of the main current path. The first control element is actuated depending on an (electrical) level applied to the first control input and therefore the main current path is interrupted. The first switching element is interconnected accordingly.

By way of example, the first switching element is a semiconductor switch, such as a power semiconductor switch. The first switching element is preferably a field-effect transistor, such as a MOSFET. In this case, the first switching element therefore has a drain and a source input as operating contacts, which are a constituent part of the main current path. The gate input forms the first control input or is a constituent part thereof. Particularly preferably, however, the first switching element is formed by means of a relay. The two operating contacts can in this case be spaced apart from one another mechanically by means of an armature and/or can mechanically bear against one another directly. The operating contacts are preferably mechanically pretensioned, for example by means of a spring, with the result that the spring force is actuated by means of the armature when there is corresponding movement. The armature is, in particular, a constituent part of a relay drive, which has an electrical coil by means of which a corresponding force is exerted on the armature when there is corresponding energization. For example, one of the connections of the coils is the first control input or is at least electrically contact-connected thereto.

For example, the first switching element has an interconnection composed of a relay and a semiconductor switch. In particular, the semiconductor switch is connected in parallel with the relay. The interconnection is preferably such that the electric current is commutated onto the semiconductor when the relay is opened, with the result that the formation of an arc in the relay is suppressed. Following this, in particular the semiconductor switch is actuated and therefore the electric current is interrupted.

The circuit breaker also has a controllable second switching element, wherein the first control input of the first switching element is connected to the second switching element. By way of example, the second switching element is a relay, a semiconductor switch or a combination thereof. In particular, a drive current is switched by means of the second switching element and in this way a specific electrical level is applied to the first control input. In this case, the second switching element in particular likewise has two operating contacts, which are formed by way of example by means of a relay or a semiconductor switch or a combination thereof. In this case, in particular, one of the operating contacts of the second switching element is electrically permanently contact-connected to the first control input of the first switching element. It is therefore possible to apply a reference potential to the first control input by means of the second switching element.

In this case, the second switching element is likewise designed to be controllable, such that it is actuated depending on specific conditions. For this purpose, the second switching element preferably has a second control input. The first switching element is therefore actuated by means of the second switching element, and in particular the first switching element is actuated when the second switching element is actuated. In this case, it is possible to design the first switching element in such a way that it is actuated even in the case of a comparatively low level applied to the first control input. It is therefore not necessary to switch comparatively high electric currents and/or electrical voltages by means of the second switching element, with the result that comparatively cost-effective components can be used for this purpose. By way of example, the electrical voltage switched by means of the second switching element is lower than 30 V or 20 V. In contrast, an electrical voltage between 100 V and 1000 V is expediently switched by means of the first switching element.

The second switching element is a constituent part of a drive circuit, which also comprises a current sensor, which is coupled to the main current path. By way of example, the current sensor is introduced into the main current path or at least operatively connected thereto for this purpose. It is therefore possible to detect by means of the current sensor the electric current conducted by means of the main current path. The current sensor itself has two outputs, wherein, during operation, the electrical voltage applied between the outputs of the current sensor is dependent on the electric current conducted by means of the main current path. The current sensor is suitably designed for this purpose. In particular, there is a functional relationship between the electric current and the electrical voltage, wherein the function is preferably continuous and/or differentiable. The electrical voltage applied between the outputs is particularly preferably substantially proportional to the electric current conducted by means of the main current path. For example, an electrical voltage of 2 V corresponds to a conducted electric current between 10 A and 100 A. Therefore, only comparatively low electrical voltages and/or comparatively low electric currents are applied in the drive circuit, in particular below 1 A, 0.5 A, 0.1 A or 0.01 A. It is therefore possible to use comparatively cost-effective component parts for the drive circuit, which further reduces production costs of the circuit breaker.

The drive circuit comprises a microcontroller-free characteristic curve circuit. In other words, the characteristic curve circuit does not have a microcontroller and/or microprocessor. The characteristic curve circuit is preferably of analog design and therefore does not comprise any digital component parts, in particular any electronic component parts. The entire drive circuit is preferably microcontroller-free and/or of analog design. In other words, the entire drive circuit does not have any digital component parts and/or electronic component parts. However, the drive circuit at least does not comprise a microprocessor/microcontroller and is therefore free of microprocessors/microcontrollers. For example, the drive circuit comprises a comparator and a Schmitt trigger. The entire circuit breaker is preferably of analog design and therefore does not have any digital/electronic component parts or at least does not have a microprocessor/microcontroller. In other words, the circuit breaker is microprocessor-free/microcontroller-free.

The characteristic curve circuit has two inputs, wherein each of the outputs of the current sensor is connected to a respective input of the characteristic curve circuit. During operation, the electrical voltage provided by means of the current sensor is therefore applied to the inputs of the characteristic curve circuit. Consequently, the electrical voltage for the characteristic curve circuit is provided by means of the current sensor. The characteristic curve circuit has two further outputs, between which a further electrical voltage is applied during operation. The further electrical voltage has a functional relationship with the electrical voltage. There is preferably a functional relationship between the further electrical voltage and the time profile of the electrical voltage. The functional relationship expediently correlates to a particular characteristic curve or at least corresponds thereto. By way of example, the further electrical voltage is different from a quiescent voltage level correlating to the rated current only if the electrical voltage exceeds a specific limit value or changes by more than a further limit value, for example increases, within a particular time window. A particular characteristic curve or at least a switching point is therefore prescribed by means of the characteristic curve circuit, such that the further electrical voltage applied between the further outputs is dependent on the particular characteristic curve.

In particular, in the case of step changes in the electric current conducted by means of the main current path, which correspond to step changes in the electrical voltage provided by means of the current sensor, within particular time windows, the further electrical voltage is specifically changed so that it preferably exceeds a particular value. In this case, a time window is expediently assigned to each step size (change) in the electric current, wherein the pairs formed in this way each define in particular a switching point of the circuit breaker. A plurality of such switching points are expediently defined by means of the characteristic curve circuit, that is to say two switching points, three switching points or more switching points. In this case, the respective step size of the electric current is mapped onto a corresponding change in the electrical voltage by means of the current sensor.

The second switching element is actuated depending on the further electrical voltage applied between the further outputs of the characteristic curve circuit. The second switching element is therefore actuated when the electrical voltage applied to the inputs of the characteristic curve circuit satisfies a particular condition. However, this electrical voltage is dependent on the electric current conducted by means of the main current path. The second switching element is therefore actuated when the electric current conducted by means of the main current path satisfies a particular condition. The second switching element is preferably actuated when a switching point is reached due to a change in the electric current, that is to say when the change in the electric current within the time window of one of the switching points is greater than or equal to the step size of the electric current of the same switching point or when the change in the electric current is equal to the step size of the electric current of one of the switching points, wherein the change takes place within the time window prescribed by means of the same switching point.

When the second switching element is actuated, the first switching element is actuated, such that in summary the latter is actuated depending on the electric current conducted by means of the main current path. By means of the characteristic curve circuit, in particular two conditions or more conditions are defined, which the time profile of the electric current and therefore also the time profile of the electrical voltage have to have so that the second switching element is actuated.

Owing to the microcontroller-free characteristic curve circuit, no comparatively costly component parts are required, for which reason production costs are reduced. Electric currents/electrical voltages present in the drive circuit during operation are also comparatively low, such that comparatively cost-effective component parts can be used for these. The production costs of the circuit breaker are therefore further reduced. Since the triggering characteristic of the circuit breaker is set by means of the characteristic curve circuit, it is possible to use the circuit breaker for a wide range of applications by means of accordingly adjusting the characteristic curve circuit. In this case, merely an exchange of the individual components of the characteristic curve circuit or the entire characteristic curve circuit is necessary, whereas the further components do not always have to be changed. A comparatively large amount of identical parts can therefore be used, which further reduces production costs.

A readjustment of the circuit breaker, in particular a redesign of the circuit breaker, is not necessary here either. Since the characteristic curve circuit is also designed to be microcontroller-free, it is comparatively insensitive and therefore robust. Consequently, reliability and safety are increased. The triggering characteristic is also set by means of the characteristic curve circuit, which can be manufactured comparatively precisely, and which therefore has comparatively low manufacturing tolerances. Consequently, it is not necessary to calibrate each circuit breaker after it has been manufactured or during operation, which reduces production and operating costs.

By way of example, one of the outputs of the current sensor and/or one of the inputs of the characteristic curve circuit is electrically connected to ground and is therefore at the electrical potential of ground. As an alternative or in combination therewith, for example, one of the further outputs of the characteristic curve circuit is electrically connected to ground and therefore at the electrical potential of ground. As a result, an interconnection of the circuit breaker is simplified.

The circuit breaker particularly preferably has a comparator circuit, which comprises in particular a comparator. The comparator circuit is expediently likewise of analog design and has a Schmitt trigger. The comparator circuit has two inputs, which are connected to the further outputs of the characteristic curve circuit. In particular, these are electrically connected to one another directly, such that the further electrical voltage is applied to the inputs of the comparator circuit during operation. The comparator circuit also has a reference input, which is expediently connected to an electrical reference potential. In particular, a particular constant electrical voltage with respect to a further electrical potential is provided by means of the reference potential, wherein said electrical potential is likewise applied to the comparator circuit, for example. The electrical potential of one of the further outputs of the characteristic curve circuit is particularly preferably used here as further electrical. An interconnection is therefore simplified.

In addition, the comparator circuit has an output, which is connected to the possible second control input of the second switching element. In particular, an electrical level is applied to the output of the comparator circuit if the further electrical voltage applied between the further outputs of the characteristic curve circuit satisfies a particular condition with respect to the reference potential. In particular, the electrical potential applied to one of the inputs of the comparator circuit is compared with respect to the electrical potential applied to the reference input, that is to say preferably the reference potential. In particular, in this case, the other input of the comparator circuit is electrically connected to ground. If, for example, the electrical potential applied to the one of the inputs is greater than the reference potential, a particular electrical level is applied to the output of the comparator circuit, said particular electrical level corresponding to the quiescent voltage level that can be assigned to the rated current. The second switching element is therefore actuated when the electrical potential at the one in the inputs thereof is greater than the reference potential.

The outputs of the current sensor are particularly preferably DC-isolated from the main current path. The entire drive circuit is preferably DC-isolated from the main current path, which increases safety and the protection of the system and/or people. By way of example, the current sensor comprises a Hall sensor or is formed by means thereof. During operation, a magnetic field surrounding the main current path is detected by means of the Hall sensor, said magnetic field being brought about owing to the electric current conducted by way of said path. In one alternative, for example, the current sensor is a magnetoresistive sensor or comprises same. During operation, the magnetic field surrounding the main current path is likewise detected by means of the magnetoresistive sensor, said magnetic field being brought about owing to the electric current. The current sensor is therefore spaced apart from the main current path, which facilitates DC isolation. As an alternative, the current sensor comprises a shunt, for example, that is to say expediently a measurement resistor, which is introduced into the main current path. The current sensor is therefore at least partly also a constituent part of the main current path. The current sensor preferably comprises a DC isolation of the shunt with respect to the outputs, with the result that the DC isolation is also implemented in this way. As an alternative, said DC isolation is not present, which reduces production costs.

One of the inputs of the characteristic curve circuit is preferably connected to one of the further outputs of the characteristic curve circuit by means of a triggering path. In other words, the triggering path is present between said input of the characteristic curve circuit and the further output of the characteristic curve circuit, and said input of the characteristic curve circuit is connected to the further output of the characteristic curve circuit by means of the triggering path. By way of example, a path, which has a plurality of electrical components, is likewise present between the other input of the characteristic curve circuit, subsequently also referred to in particular as “other input”, and the other further output of the characteristic curve circuit, subsequently also referred to in particular as “other further output”. However, the other input of the characteristic curve circuit is particularly preferably connected to the other further output of the characteristic curve circuit directly and therefore is electrically contact-connected thereto directly. Consequently, the electrical potential applied to the other input of the characteristic curve circuit is equal to the electrical potential applied to the other further output of the characteristic curve circuit, and these are provided mechanically preferably by means of the same terminal. The other input of the characteristic curve circuit and the other further output of the characteristic curve circuit are preferably contact-connected to ground. A design of the circuit breaker is therefore simplified. In particular, a two-port element is therefore formed. The characteristic curve functionality is provided by means of the triggering path. Only an adjustment to the triggering path is therefore necessary to adapt the circuit breaker to the respective case of application.

The triggering path expediently has a first resistor. The input of the characteristic curve circuit is therefore connected to the further output of the characteristic curve circuit by means of the first resistor. By way of example, additional electrical component parts are arranged here between the first resistor and the input or the output. The first resistor is connected to the other further output and therefore also to the other input of the characteristic curve circuit on the side of the further output by means of a first capacitance. The first capacitance is particularly preferably a capacitor.

If the electrical voltage is applied to both inputs of the characteristic curve circuit, a flow of current, by means of which the first capacitor is charged, arises across the first resistor. The charging duration is set in this case by means of the first resistor. The voltage applied to the first capacitor and its temporal profile arise depending on the electrical voltage applied at the inputs of the characteristic curve circuit and the choice of the first resistor. The electrical voltage applied to the first capacitor is in this case in particular that further electrical voltage which is applied to the further outputs of the characteristic curve circuit.

Owing to the use of the first capacitance and the first resistor, the profile of the electrical voltage applied to the inputs of the characteristic curve circuit differs from the profile of the further electrical voltage applied to the further outputs of the characteristic curve circuit. The further electrical voltage is therefore dependent on the selection of the first resistance and the selection of the first capacitance and on the applied electrical voltage. If said voltage exhibits comparatively rapid fluctuation, that is to say in particular voltage peaks, it is smoothed by means of the first resistor and first capacitance. In other words, the first resistor and the first capacitance act as a low-pass filter. As a result thereof, in particular the second switching element is not actuated and therefore the circuit breaker is not triggered. It is therefore possible to at least partly imitate the behavior of a thermal circuit breaker by means of suitable selection of the first resistance and the first capacitance.

A characteristic branch, which has a series circuit composed of a capacitance and a resistor, is preferably connected in parallel with the first capacitance. The capacitance is expediently formed by means of a capacitor. By way of example, the capacitance is located here on the side of the first resistor or on the side of the other further output/input with respect to the associated resistor. In particular, the characteristic branch is formed by means of the series circuit. Therefore, in addition to the first capacitance, a further condition for the further electrical voltage is also specified by means of the characteristic branch. In particular, a low-pass filter is formed by means of the characteristic branch and/or a low-pass filter forms the characteristic branch. The low-pass filter is preferably linear.

By means of the characteristic branch, it is possible to change the already existing characteristic curve by means of adding a further switching point, wherein the switching point defines in particular a particular temporal increase in the applied electrical voltage and therefore in the electric current conducted by means of the main current path, within a particular time window. When the switching points are realized or exceeded, the second switching element is suitably driven. In other words, in this case the further electrical voltage satisfies a particular condition, which leads to the switching of the second switching element.

For example, only a single such characteristic branch is present. However, the circuit breaker, that is to say the characteristic curve circuit, particularly preferably comprises at least one such further characteristic branch, preferably a plurality of further characteristic branches. In particular, each of these characteristic branches is formed by means of the respective capacitance and the respective resistor. In particular, the characteristic branches are identical to one another and technically differ in each case only in terms of the dimensioning of the respective component parts but not in terms of the arrangement and/or type of the component parts.

The characteristic branches preferably differ in particular owing to the selection of the respective resistance, wherein, for example, the capacitances are always the same. As an alternative thereto, for example, the capacitances are always the same and the resistances are different. Both the resistances and the capacitances particularly preferably differ between at least two of the characteristic branches. The circuit breaker preferably has 4, 5, 6, 8, 10 or more such characteristic branches.

In particular, a switching point of the characteristic curve or an entire characteristic curve is determined by means of each of the characteristic branches, that is to say a condition is defined. These correspond here to a change in the electric current guided by means of the main current within a particular time window. If one of these switching points is exceeded, the respective condition is satisfied, which is indicated by means of the further electrical voltage. By way of example, in this case, that is to say when a respective condition is satisfied, the further electrical voltage is greater than a particular limit value, in particular greater than the possible reference potential. In this case, the second switching element is therefore actuated.

The first resistor is particularly preferably connected on the side of the input of the characteristic curve circuit to the other further output of the characteristic curve circuit by means of a second resistor. The second resistor is therefore also connected to the other input of the characteristic curve circuit. The second resistor preferably has a comparatively large value, such that said second resistor has a comparatively high impedance. The resistance value of the second resistor is greater than 20 kΩ (kilo Ohm), 50 kΩ, 100 kΩ, for example. The further electrical voltage is therefore essentially not influenced by the second resistor.

In particular, after the circuit breaker has been triggered, that is to say when the electrical voltage is no longer provided by means of the current sensor, the first capacitance and the possible further capacitances are discharged by means of the second resistor. The circuit breaker is therefore transferred to a safe state after triggering and an electrical voltage is no longer applied to the individual component parts.

In one alternative, the triggering path has a third resistor, which is connected in parallel with the first capacitance. The third resistor is therefore likewise electrically contact-connected to the two other outputs of the characteristic curve circuit. As a result thereof, the first capacitance is always discharged by means of the third resistor, such that any voltage peaks in the electrical voltage are absorbed in this way, for which reason a thermal behavior of the circuit breaker can be imitated. An excessive charging of the first capacitance is also prevented, for which reason it always exhibits its mode of operation. The switching point or the characteristic curve provided by means of the triggering path is therefore adjusted further by means of the third resistor.

The triggering path preferably comprises a diode, which is arranged between the first resistor and the input of the characteristic curve circuit. In this case, in particular, a flow of current from the input of the characteristic curve circuit to the first resistor is possible, but not in the opposite direction. As an alternative or preferably in combination, a diode is connected between the further output of the characteristic curve circuit and the first resistor and therefore also between the first capacitance and the further output of the characteristic curve circuit. A flow of electric current from the first resistor to the further output of the characteristic curve circuit is preferably possible due to the reverse direction. The two diodes are particularly preferably present, such that a flow of current via the first resistor is possible. On account of the two diodes, a mode of operation of the triggering path is improved and it is ensured that the first capacitance is always discharged on the side of the further outputs of the characteristic curve circuit.

In a further alternative, an additional resistor is connected between the further output of the characteristic curve circuit and the first resistor and therefore also between the first capacitance and the further output of the characteristic curve circuit. In this case, the function of one of the afore-mentioned diodes is at least partly taken over by means of the further resistor.

For example, only the single triggering path is present. Particularly preferably, however, the characteristic curve circuit comprises at least one further triggering path or more further triggering paths, for example 2, 3, 4, 5 or 10 further triggering paths. The further triggering paths are connected in parallel with the triggering path and are therefore connected to the one input of the characteristic curve circuit and the one other output of the characteristic curve circuit. All of the triggering paths are preferably of an identical design to one another and therefore have in particular the same number and/or types of component parts. The respective interconnection thereof does not differ either. However, at least one of the component parts of the triggering paths expediently differs on account of the dimensioning/the respective value. In particular, the first, second and/or third resistor are different at least between two of the triggering paths. It is thus possible to use the characteristic curve circuit to provide a comparatively complex characteristic curve based on which the circuit breaker is triggered.

The values for the first resistor, the first capacitance and the further capacitances/resistors are determined, for example, by means of a heuristic method and/or an iterative method, in particular if several such triggering paths/characteristic branches are present.

If a component is referred to as first, second, third, . . . component, in particular only one particular component is intended to be understood thereby. In particular, it does not mean that a particular number of such components is present. In particular, it is not implied that the second resistor is present if the third resistor is present.

Other features which are considered as characteristic for the invention are set forth in the appended claims.

Although the invention is illustrated and described herein as embodied in a circuit breaker, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 shows a schematic diagram of a circuit breaker having a characteristic curve circuit;

FIG. 2 simplifies a circuit diagram of an embodiment of the characteristic curve circuit;

FIG. 3 shows a characteristic curve provided by means of the characteristic curve circuit; and

FIG. 4 shows a further embodiment of the characteristic curve circuit according to FIG. 2.

Parts and elements that correspond to one another functionally or structurally are provided with the same reference signs throughout the figures.

### DETAILED DESCRIPTION OF THE INVENTION

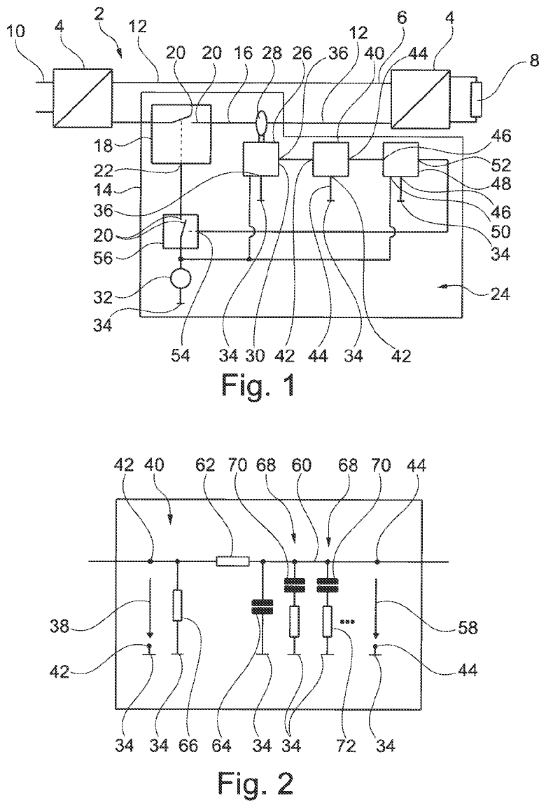

Referring now to the figures of the drawing in detail and first, in particular, to FIG. 1 thereof, there is shown a simplified schematic of a DC system 2 having two converters 4, which are connected to one another by means of a DC circuit 6. A load 8 is energized by means of one of the converters 4. By way of example, the DC system 2 is a constituent part of a charging column for the use of electric powered vehicles, such that the load 8 represents a motor vehicle or the like. As an alternative, the DC system 2 is a constituent part of a telecommunications or data center system, for example, and the load 8 is formed by a mobile radio system (station) or another component. One of the converters 4 is configured as a rectifier and connected to a supply network 10, which, for example, conducts a DC (electrical) voltage or an AC (electrical) voltage. For example, the supply network 10 is provided by a battery or another energy storage device.

The DC circuit 6 has two current paths 12, by means of which a transmission of electrical energy between the two converters 4 is made possible during operation. For the purpose of protection in the event of a fault, a circuit breaker 14 is introduced into one of the current paths 12. The circuit breaker therefore forms one of the current paths 12 at least in part. The circuit breaker 14 has a main current path 16, which is connected to further constituent parts of the associated current path 12 by way of terminals (not illustrated in more detail). In other words, the main current path 16 forms the current path 12 at least in part. The circuit breaker 14 has a first switching element 18 having two operating contacts 20, wherein an electrical resistance can be set between said operating contacts. In addition, the first switching element 18 has a first control input 22, by means of which the electrical resistance between the two operating contacts 20 is set. The first switching element 18 is thus designed to be controllable.

By way of example, the first switching element 18 is formed by means of a semiconductor switch, for example a power semiconductor switch. In this case, the electrical resistance between the two operating contacts 20, which are provided, in particular, by means of “drain” and “source”, is set by means of changing a charging zone. However, the first switching element 18 is preferably formed by means of a relay and the operating contacts 20 are mounted so as to be movable with respect to one another, with the result that the electrical resistance is increased by means of spacing them apart. At least one of the operating contacts 20 is operatively connected to an armature (not illustrated in more detail), wherein the position of the two operating contacts 20 with respect to one another is set by means of the armature. The armature is produced from a magnetic or ferromagnetic material, for example, and is driven by means of a coil of a relay drive (not illustrated in more detail). If a particular electrical voltage is applied to the first control input 22, the coil is energized.

The circuit breaker 14 also comprises a drive circuit 24, by means of which the first switching element 18 is driven. In other words, the drive circuit 24 is connected to the first control input 22 of the first switching element 18. The drive circuit 24 has a current sensor 26, which comprises a Hall sensor 28. The Hall sensor 28 in this case surrounds the main current path 16 on the circumferential side, with the result that said sensor can be used to detect a magnetic field, which is brought about on account of an electric current conducted by means of the main current path 16, said current normally being 30 A (rated current “irated”).

The Hall sensor 28 is mechanically spaced apart from the main current path 16 and is operated, that is to say energized, by means of a on evaluation circuit 30 of the current sensor 26. For this purpose, the evaluation circuit 30 is electrically connected to a DC voltage source 32, by means of which an electrical DC voltage of 24 V is provided with respect to ground 34, wherein the evaluation circuit 30 is likewise electrically connected to ground 34. In further alternatives that are not shown, the electrical DC voltage is between 1 V and 50 V, between 10 V and 30 V and is, for example, 12 V, with respect to ground 34. In addition, the current sensor 26, namely the evaluation circuit 30, has two outputs 36, one of which is likewise connected to ground. In other words, the electrical potential applied to said output 36 is always ground 34. The electrical voltage 38 applied between the outputs 36 (FIG. 2) is dependent on the electric current conducted by means of the main current path 16. In particular, the electrical voltage 38 is directly proportional to the current conducted by means of the main current path 16 due to the use of the Hall sensor 28. In this case, an electric current of 30 A conducted by means of the main current path 16 corresponds to an electrical voltage 38 of 0.9 V, minus a fixed offset, applied between the outputs 36 and an electric current of 60 A conducted by means of the main current path 16 corresponds to an electrical voltage 38 of 1.8 V, minus the fixed offset, applied between the outputs 36. The proportionality factor is therefore 0.03 V/A. In addition, the outputs 36 of the current sensor 26 are DC-isolated from the main current path 16 due to the use of the Hall sensor 28.

In one alternative, a magneto-resistive sensor is used instead of the Hall sensor 28. In this case, too, the outputs 36 of the current sensor 26 are DC-isolated from the main current path 16 due to design. In a further alternative, a shunt, which is introduced into the main current path 16, is used instead of the Hall sensor 28. In this case, the outputs 36 are DC-isolated from the main current path 16 by means of appropriate adjustment of the evaluation circuit 30.

The drive circuit 24 also has a characteristic curve circuit 40, which comprises two inputs 42 and two further outputs 44. One of the inputs 42 and one of the outputs 44 are formed by means of the same physical terminal and connected to ground 34. Said input 42 of the characteristic curve circuit 40 is therefore also electrically contact-connected to one of the outputs 36 of the current sensor 26. The other input 42 of the characteristic curve circuit 40 is electrically contact-connected to the other output 36 of the current sensor 26.

The other output 44 of the characteristic curve 40 is connected to one of a total of two inputs 46 of a comparator circuit 48, which comprises a comparator (not illustrated in more detail). The other input 46 of the comparator circuit 48 is connected to ground 34. In addition, the comparator circuit 48 has a reference input 50, which is connected to the DC voltage source 32. The electrical potential provided by means of the DC voltage source 32 is therefore applied as reference potential, namely 24 V, to the reference input 50 with respect to ground 34. The comparator circuit 48 also comprises an output 52, wherein a level is then applied thereto only when the electrical voltage applied between the inputs 46 of the comparator circuit 48 is greater than the electrical voltage between the reference input 50 and ground 34. In one development, a reference potential is adjusted in particular by means of the comparator circuit 48.

The output 52 of the comparator circuit 48 is connected to a second control input 54 of a controllable second switching element 56, which is connected between the first control input 22 and the DC voltage source 32. The second switching element 56 is provided by means of a semiconductor switch, namely a MOSFET. The second switching element 56 therefore likewise has two operating contacts 20, of which one is formed by means of “drain” and the other is formed by means of “source”. By means of the operating contacts 20, it is possible to set the first control input 22 to the electrical potential provided by means of the DC voltage source 32. The operating contacts 20 of the second switching element 56 are set here of the second control input 54, which is formed by means of “gate.”

The second switching element 56 is therefore actuated depending on a further electrical voltage 58 applied between the further outputs 44 of the characteristic curve circuit 40 (FIG. 2). For this purpose, namely the further outputs 44 of the characteristic curve circuit 40 are connected to the inputs 50 of the comparator circuit 48, the output 52 of which is connected to the second control input 54. In this case, the output 52 has a level only when the further electrical voltage 58 is greater than the electrical voltage provided by means of the DC voltage source 32, which thus forms a reference potential. The characteristic curve circuit 40 and the further constituent parts of the drive circuit 24 are produced by means of analog component parts and, by means of the microcontroller-free characteristic curve circuit 40, there is a functional relationship between the further electrical voltage 58 applied to the outputs 42 of the characteristic curve circuit 40 and the electrical voltage 38 applied to the inputs 42 of the characteristic curve circuit 40 and thus also to the outputs 36 of the current sensor 26. At least the drive circuit 24 is microcontroller-free.

FIG. 2 illustrates a first embodiment of the characteristic curve circuit 40 having the two inputs 42, between which the electrical voltage 38 is applied during operation. The further electrical voltage 58 is applied between the further outputs 44 of the characteristic curve circuit 40 during operation. One of the inputs 42 of the characteristic curve circuit 40 is connected to one of the further outputs 44 of the characteristic curve circuit 40 by means of a triggering path 60. The other input 42 and the other output 44 of the characteristic curve circuit 40 are electrically connected to ground 34 and thus electrically contact-connected to one another directly.

The triggering path 60 has a first resistor 62, which is connected between the input 42 of the characteristic curve circuit 40 and the further output 44 of the characteristic curve circuit 40 and thus connects these to one another. The value of the first resistor 62 is 1 kΩ (kOhm). On the side of the associated further output 44 of the characteristic curve circuit 40, the first resistor 62 is connected to the other further output 44 and thus to ground 34 by means of a first capacitance 64. The first capacitance 64 is formed by means of a capacitor and has a value of 3.16 μF. On the side of the input 42, the first resistor 62 is connected to the other further output 44 of the characteristic curve circuit 40 and thus also to ground 34 by means of a second resistor 66. The value of the second resistor 66 in this case is 51 kΩ.

Several characteristic branches 68, in this case four characteristic branches 68, with two being shown here, are connected in parallel with the first capacitance 64. In other words, the two further outputs 44 in the characteristic curve circuit 40 are electrically connected to one another by means of the characteristic branches 68. Each characteristic branch 68 is formed by means of a series circuit composed of a capacitance 70 and a resistor 72, wherein, in this example, the capacitance 70 is located on the side of the first resistor 62 with respect to the respective resistor 72. The characteristic branches 68 are thus of identical design, wherein the value of the capacitance 70 in one of the characteristic branches 68 is equal to 3.16 μF, and wherein the value of the resistor 72 of the same characteristic branch 68 is equal to 1.049 kΩ. The value of the capacitance 70 in a further one of the characteristic branches 68 is equal to 4.64 μF and the value of the resistor 72 of this characteristic branch 68 is equal to 4.319 kΩ. The value of the capacitance 70 in a further one of the characteristic branches 68 is equal to 8.25 μF and the value of the resistor 72 of this characteristic branch 68 is equal to 475.4 Ohm.

During operation, the first capacitance 64 is charged by means of the electrical voltage 38, wherein the further electrical voltage 58 is adjusted to the first capacitance 64. If the electrical voltage 38 exhibits fluctuations, these are partly smoothed on account of the first resistor 72 and the first capacitance 64 acting as low-pass filter and the characteristic branches 68. If there is a comparatively great change in the electrical voltage 38 within a particular time window, comparatively rapid charging of the first capacitance 64 and the capacitances 70 is possible, with the result that the further electrical voltage 58 also changes. In other words, the triggering path 60 acts as a low-pass filter of the nth order, wherein n is the number of characteristic branches 68 minus “1”. n is thus equal to the number of capacitances 64, 70 of the triggering path 60 and a transfer function is formed by means thereof.

As a result thereof, the electrical voltage applied to the inputs 64 of the comparator circuit 48 changes, said electrical voltage therefore being greater than the electrical voltage formed between the reference input 50 and ground 34. As a result thereof, the second switching element 56 is actuated and the first switching element 18 is therefore opened, with the result that the flow of electric current via the main current path 16 is interrupted.

By means of the selection of the individual values for the electrical component parts of the characteristic curve circuit 40, it is ensured that the first switching element 18 is also triggered within a particular time window given particular changes in the electrical voltage 38 that correspond to changes in the electric current through the main current path 16.

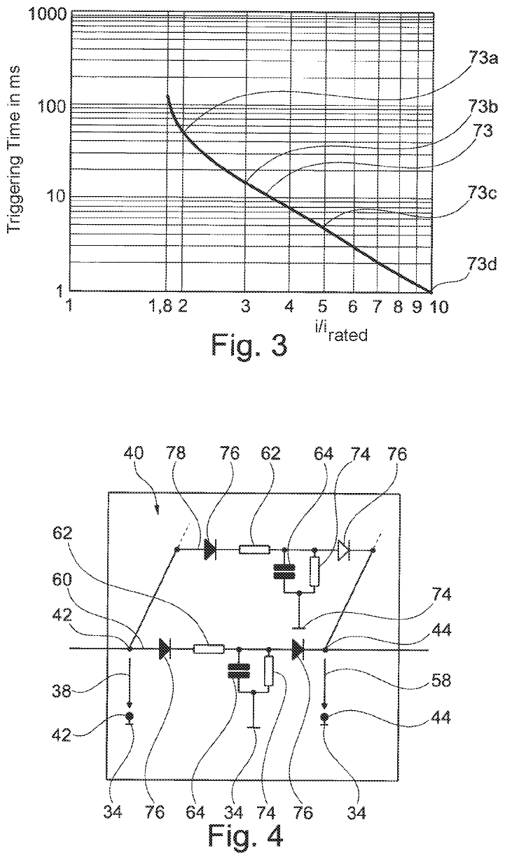

FIG. 3 illustrates a characteristic curve 73 provided by means of the characteristic curve circuit 40, wherein the triggering time of the circuit breaker 14 in milliseconds (ms) is plotted against the triggering current, that is to say the electric current conducted by way of the main current path 16 as a multiple of the rated current, in this case 30 A. The comparator circuit 48 ensures that triggering is effected only from a constant 1.8 times the rated current. The reference potential is suitably adapted for this purpose.

A first switching point 73a, a second switching point 73b, a third switching point 73c and a fourth switching point 73d, that is to say a total of four switching points, result on account of the first capacitance 64 and the first resistor 62 and also on account of the three characteristic branches 68. The first switching point 73a corresponds to the increase in the electric current conducted by the main current path 16 to over twice the rated current in 50 ms, the second switching point 73b corresponds to the increase in the electric current conducted by the main current path 16 to over triple the rated current in 15 ms, the third switching point 73c corresponds to the increase in the electric current conducted by the main current path 16 to over five times the rated current in 5 ms and the fourth switching point 73d corresponds to the increase in the electric current conducted by the main current path 16 to over ten times the rated current in 1 ms. When one of the switching points 73a, 73b, 73c, 73d and thus the characteristic curve 73 is exceeded on account of the change in the electric current conducted by means of the main current path 16, the second switching element 56 is always actuated and therefore the circuit breaker 14 is always triggered.

FIG. 4 shows a further embodiment of the characteristic curve circuit 40, wherein the triggering path 60 is also present here between one of the inputs 42 and one of the further outputs 44. The other input 42 of the characteristic curve circuit 40 and the other further output 44 of the characteristic curve circuit 40 is again connected to ground 34. The first resistor 62 and the first capacitance 64 are furthermore also present. However, the first capacitance 64 is bypassed by means of a third resistor 74, which is therefore connected in parallel with the first capacitance 64.

In addition, the triggering path 60 has two diodes 76. The first resistor 62 is located between the two diodes 76. In other words, an electrical parallel circuit composed of the two diodes 76 and the first resistor 62 is formed between the input 42 of the characteristic curve circuit 40 and the further output 44 of the characteristic curve circuit 40. One of the diodes 76 is therefore connected between the first resistor 62 and the input 42 of the characteristic curve circuit 40 and the other diode 76 is therefore connected between the further output 44 of the characteristic curve circuit 40 and both the first resistor 62 and the first capacitance 64. In this case, a flow of current from the input 42 of the characteristic curve circuit 40 to the further output 44 of the characteristic curve circuit 40 is possible owing to the diodes 76, but not in the reverse direction.

A further triggering path 78, which is identical to the triggering path 60 and thus likewise has the diodes 76, the first resistor 62 and the first capacitance 64 and the third resistor 74, is electrically connected in parallel with the triggering path 60. The interconnection thereof is also identical. However, the values of the first resistor 62, the third resistor 74 and the first capacitance 64 are different. The diodes 76 are always identical or different. In a further alternative, several such further triggering paths 78 are provided, wherein the values of the first and third resistor 62, 74 and the first capacitance 64 are different.

During operation, when the applied electrical voltage 38 changes, peaks are also smoothed by means of the first resistor 62 and the first capacitance 64. The first capacitance 64 is discharged by means of the third resistor 74 such that the further electrical voltage 58 applied to the outputs 44 in normal operation remains below a particular value. By means of the diodes 76, it is ensured that the first capacitance 64 is always charged on the side of the outputs 44 of the characteristic curve circuit 40.

Only when the change in the electrical voltage 38 satisfies a particular condition and changes by a comparatively large value within a comparatively short time window does the further electrical voltage 58 also change. In this case, different conditions are specified by means of the triggering path 60 and the further triggering path 78, that is to say the value of the change in the electrical voltage 38 and the associated time window. The electrical voltage 38 is in turn proportional to the electric current conducted by means of the main current path 16.

In summary, the circuit breaker 14 is used to protect the DC system 2 or a DC link, which is a high-voltage DC system with limited permanent short-circuit power, for example. This is provided, in particular, on account of the converters 4. The DC system 2 is a constituent part of a motor vehicle, in particular of an electric vehicle, a charging column, a telecommunications or data center infrastructure, for example.

By way of example, the first switching element 18 is a switching element that can be triggered remotely, such as a mechanical relay, a semiconductor relay, a hybrid relay or a semiconductor switch. The electric current conducted by means of the main current path 16 is detected by means of the current sensor 26, which has a DC isolation, and by means thereof the electric current of the main current path 16 is mapped approximately linearly onto the electrical voltage 38. In this case, the sensor 26 is designed in such a way that it can detect/measure in particular the multiple of the rated current of the DC system 2 for several milliseconds, without damage occurring. It is also possible to measure any current peaks. By way of example, a possible offset can be scaled and/or eliminated by means of the evaluation circuit 30 of the current sensor 26.

A prescribed current/time characteristic curve can be mapped by purely analog component parts by means of the characteristic curve circuit 40. In other words, the characteristic curve circuit 40 is an analog circuit and is produced only by means of passive components.

In one alternative (FIG. 2), there is a parallel arrangement of series RC combinations, that is to say the characteristic branches 68. In this case, a series resistor, namely the first resistor 62, and a discharging resistor, namely the second resistor 76, are present. A characteristic curve point, that is to say a switching point, upon the exceeding of which the first switching element 18 is actuated, is provided by means of the first resistor 62 and the first capacitance 64. The further characteristic curve points are set by means of the characteristic branches 68. The capacitances 64, 70 are discharged by means of the second resistor 66, which has a high impedance, after the first switching element 18 has been disconnected.

In another variant (FIG. 3), one of the first capacitances 64 is charged by the respective first resistor 62 at each characteristic curve point, that is to say each switching point. Each first capacitance 64 is respectively discharged via the associated third resistor 74. This is therefore a T-two-port arrangement. The triggering paths 60, 78 are decoupled by means of the diodes 76.

When the further electrical voltage 58 reaches a particular value, that is to say in particular exceeds a limit value, the second switching element 46 is actuated, that is to say the drive circuit 24 is triggered. In this case, the second switching element 56 is designed as a semiconductor switch, with the result that a reaction time is reduced. As a result thereof, the first switching element 18 is actuated, wherein only a comparatively low time delay prevails.

By way of example, the circuit breaker 14 comprises a further sensor system, by means of which other types of fault in the DC system 2, for example fault arcs, can be detected. The further sensor system is likewise connected in particular to the first control input 22, such that the first switching element 18 can likewise be triggered by means of the sensor system.

The invention is not restricted to the exemplary embodiments described above. Instead, other variants of the invention may also be derived therefrom by a person skilled in the art without departing from the subject matter of the invention. All of the individual features described in connection with the individual exemplary embodiments are furthermore in particular also able to be combined with one another in other ways without departing from the subject matter of the invention.

The following is a summary list of reference numerals and the corresponding structure used in the above description of the invention:
2 DC system
4 Converter
6 DC circuit
8 Load
10 Supply network
12 Current path
14 Circuit breaker
16 Main current path
18 First switching element
20 Operating contact
22 First control input
24 Drive circuit
26 Current sensor
28 Hall sensor
30 Evaluation circuit
32 DC voltage source
34 Ground
36 Output
38 Electrical voltage
40 Characteristic curve circuit
42 Input
44 Further output
46 Input
48 Comparator circuit
50 Reference input
52 Output
54 Second control input
56 Second switching element
58 Further electrical voltage
60 Triggering path
62 First resistor
64 First capacitance
66 Second resistor
68 Characteristic branch
70 Capacitance
72 Resistor
73 Characteristic curve
74 Third resistor
76 Diode
78 Further triggering path

1. A circuit breaker, comprising:
a main current path for conducting an electric current;
a controllable first switching element in said main current path, said first switching element having a first control input;
a microcontroller-free characteristic curve circuit having inputs and outputs;
a current sensor coupled to said main current path, said current sensor having two outputs, with an electrical voltage applied between said two outputs being dependent on the electric current conducted by said main current path;
each of said two outputs of said current sensor being connected to a respective input of said microcontroller-free characteristic curve circuit; and
a controllable second switching element of a drive circuit connected to said first control input of said first switching element, said controllable second switching element being actuated in dependence on a further electrical voltage applied between said outputs of said characteristic curve circuit, wherein a functional relationship exists between the further electrical voltage and the electrical voltage between said two outputs of said current sensor.

2. The circuit breaker according to claim 1, wherein said outputs of said characteristic curve circuit are connected to corresponding inputs of a comparator circuit, said comparator circuit having a reference input and an output, which is connected to a second control input of said second switching element.

3. The circuit breaker according to claim 1, wherein said outputs of said current sensor are DC-isolated from said main current path.

4. The circuit breaker according to claim 1, wherein one of said inputs of said characteristic curve circuit is connected to one of said outputs of said characteristic curve circuit by way of a triggering path, and wherein another one of said inputs of said characteristic curve circuit is connected directly to another one of said outputs of said characteristic curve circuit.

5. The circuit breaker according to claim 4, wherein said triggering path has a first resistor, which is connected on a side of one of said outputs to another said output by way of a first capacitance.

6. The circuit breaker according to claim 5, which further comprises a characteristic branch, which has a series circuit composed of a capacitance and a resistor, and which is connected in parallel with said first capacitance.

7. The circuit breaker according to claim 6, which comprises further characteristic branches connected in parallel with said first capacitance.

8. The circuit breaker according to claim 5, wherein said first resistor is connected on a side of said input to another said output by way of a second resistor.

9. The circuit breaker according to claim 8, wherein said triggering path comprises a third resistor connected in parallel with said first capacitance.

10. The circuit breaker according to claim 5, wherein said triggering path comprises a further resistor connected in parallel with said first capacitance.

11. The circuit breaker according to claim 10, wherein said triggering path has two diodes, wherein a first said diode is connected between said first resistor and an input and a second said diode is connected between said output and both said first resistor and said first capacitance.

12. The circuit breaker according to claim 10, wherein said triggering path is a first triggering path and wherein the circuit breaker comprises further triggering paths connected in parallel with said first triggering path.
